(19) United States
(12) Patent Application Publication
(10) Pub. No.: US 2006/0185649 A1
(43) Pub. Date: Aug. 24, 2006

(54) Internal combustion engine provided with an accumulator injection system

(75) Inventors: Kai-Uwe Muench, St. Augustin (DE); Joerg Schlueter, Wesseling (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Deutz Aktiengesellschaft, Koeln (DE)

(21) Appl. No.: 10/550,570

(22) PCT Filed: Mar. 6, 2004
(86) PCT No.: PCT/EP04/02312

§ 371 Date: Sep. 27, 2005

(30) Foreign Application Priority Data
Mar. 28, 2003 (DE) 103 14 029.8

(51) Int. Cl. F02M 63/00

(52) U.S. Cl. 123/447

(57) ABSTRACT

An internal combustion engine includes an injection system that is configured as a high-pressure accumulator system in which the number of parts is small and the injection system can be easily assembled. The connecting fittings for the connection of the high-pressure lines are laterally offset with respect to the appertaining injection valves and in that the absolute magnitude of said offset is identical for all injection valves of a row of cylinders of the internal combustion engine.

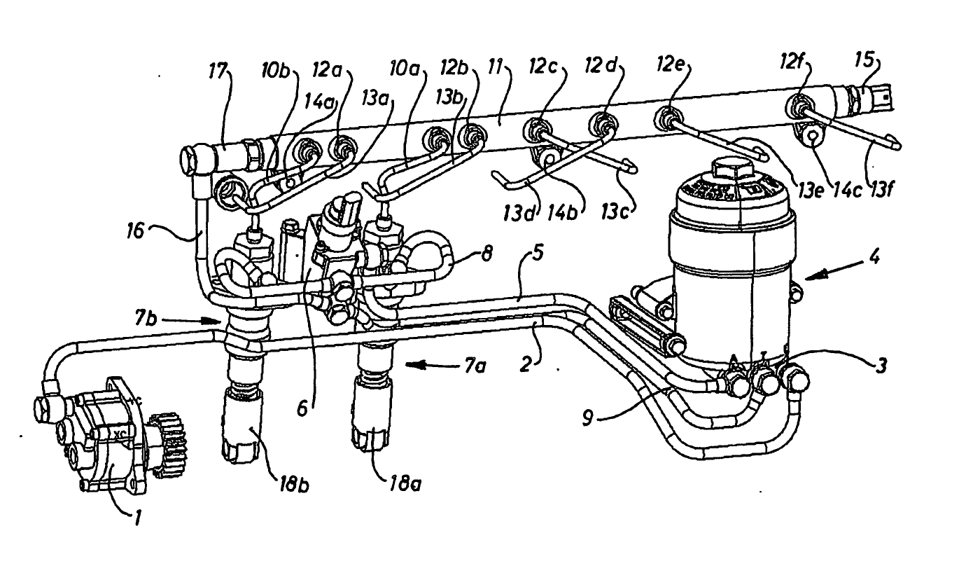

The present invention relates to an internal combustion engine with an injection system that is configured as a high-pressure accumulator system, whereby at least one high-pressure pump is connected via a high-pressure supply line to a tubular high-pressure accumulator having connection fittings to which high-pressure lines are connected that establish valve-controlled flow connections to injection valves that are used in the cylinder head of the internal combustion engine and that protrude into working areas formed by the cylinders, the pistons and the cylinder head.

Such an internal combustion engine is known from German patent application DE 199 365 34 A1. This internal combustion engine has a tubular high-pressure accumulator that is attached to the internal combustion engine. The special feature of this tubular high-pressure accumulator is that a continuous connection strip is shaped onto the high-pressure accumulator or else there are connection fittings shaped on that are configured with such a width that the bores for connecting the high-pressure lines can be positioned at different places of the connection fittings. As a result, it should be possible to use a high-pressure accumulator part for similar internal combustion engines.

The invention is based on the objective of providing an internal combustion engine having a high-pressure accumulator system with a small number of parts so as to facilitate the assembly of the injection system.

This objective is achieved in that the connection fittings are arranged laterally offset with respect to the appertaining injection valves and in that the absolute magnitude of the offset is the same for all of the injection valves of one cylinder row of the internal combustion engine. The lateral offset of the connection fittings relative to the appertaining injection valves—which are each fitted with an electrically operated control block and which are preferably arranged in the middle of the appertaining cylinders in the preferably shared cylinder head of the cylinders of one cylinder row—allows the parts of the injection system to be assembled without any problem since, for instance, the injection valves with their high-pressure connections—which optionally exit laterally from the cylinder head—and the tubular high-pressure accumulator are assembled first and afterwards the corresponding high-pressure lines can subsequently be placed between the injection valves or between the high-pressure line connections and the high-pressure accumulator system without any problem due to the lateral offset of the connections. In this context, it should be taken into consideration that the high-pressure accumulator system is arranged in close proximity to the injection valves in order to keep the length of the high-pressure lines short so as to create a hydraulically stiff injection system. As a result of the fact that the absolute magnitude of the offset is the same for all of the cylinders of one cylinder row and especially matches the distance of the injection valves in the cylinder head, the injection lines can be configured at least all with the same length. This is advantageous for adjusting the injection system.

In an embodiment of the invention, the offset of at least one cylinder at the end is arranged differently from the orientation of the offset of the other cylinders. This configuration ensures that the high-pressure accumulator system has a compact design and, in particular, that it does not extend beyond one cylinder row.

In another embodiment of the invention, there are two differently shaped high-pressure lines for the cylinder row of the internal combustion engine. This is the case when the injection valves are provided with a lateral high-pressure line connection and this connection is pivoted by an angle relative to the transverse axis of the cylinder head. If the high-pressure line connection is oriented precisely crosswise to the longitudinal axis of the cylinder head, all of the high-pressure lines can be shaped the same in an alternative embodiment.

In another embodiment of the invention, the at least one high-pressure pump is arranged close to the cylinder head in a housing, preferably the crankcase of the internal combustion engine, and it is actuated by an injection pump cam that is arranged on the gas-exchange camshaft of the internal combustion engine. This arrangement, in turn, allows a very compact structure of the internal combustion engine and, in particular, does not require any additional drive devices for the high-pressure pump.

In a refinement of the invention, two high-pressure pumps that lie next to each other at a distance are associated with adjacent cylinders. This makes it possible to utilize compact, inexpensive high-pressure pumps. Moreover, the use of two high-pressure pumps brings about an equalization of the pressure build-up in the high-pressure accumulator.

In another embodiment, the high-pressure supply lines that connect the high-pressure pumps to the high-pressure accumulator are configured identically to each other. This minimizes the requirements in terms of parts here as well.

In a refinement of the invention, a control block for controlling or regulating the fuel pressure to be established in the high-pressure accumulator is arranged on the inlet side of the at least one high-pressure pump. Here, the control block is arranged next to the one high-pressure pump or between the two high-pressure pumps. As an alternative, the control block can be integrated into the support frame of the fuel filter. This embodiment translates into a very compact injection device.

Additional advantageous embodiments can be gleaned from the description of the drawing in which an embodiment of the invention shown in the FIGURE is described in greater detail.

The single FIGURE shows an overall view of the essential components of the accumulator injection system according to the invention. A gear-driven fuel delivery pump 1 conveys fuel from a fuel tank (not shown here) via a feed line 2 into the support frame 3 of a fuel filter 4 in the form of a cup. After the fuel flows through the fuel filter 4, it is introduced into a control block 6 via a flow line 5. The control block 6 contains a pressure-control valve and a zero-delivery throttle that is constantly discharging a small amount of fuel, whereby this amount of fuel discharged by the pressure-control valve and by the zero-delivery throttle is discharged into a return line 9. The pressure-control valve determines the amount of fuel to be fed to two high-pressure pumps 7a, 7b via a feed line 8. Fuel that is to be discharged is returned to the support frame 3 of the fuel filter 4 via the return line 9. The high-pressure pumps 7a, 7b are connected to a tubular high-pressure accumulator 11 via identically configured high-pressure supply lines 10a, 10b. Furthermore, there are connection fittings 12a, 12b, 12c, 12d, 12e, 12f on the high-pressure accumulator 11 to which high-pressure lines 13a, 13b, 13c, 13d, 13e, 13f are fastened which are not connected to injection valves or high-pressure connections (not shown here). (In the case of the high-pressure line 13a located on one end across from the connection on the connection fitting 12a, a ring-shaped opening is shown that is formed in the cylinder head and that accommodates a high-pressure connection). The high-pressure accumulator 11 is fastened to the internal combustion engine by means of fasteners 14a, 14b, 14c, particularly to the cylinder head. The high-pressure accumulator 11 has a connection for a pressure sensor 15 and, on the opposite side, a connection for a discharge line 16 that is connected to the return line 9. A pressure-limiting valve 17 is located upstream from the discharge line 16.

The high-pressure pumps 7a, 7b are installed directly in the crankcase of the internal combustion engine and they have roller tappets 18 that roll on injection pump cams that are arranged on the camshaft of the internal combustion engine between the gas-exchange cams of a cylinder unit. Here, the gas-exchange cams, the injection pump cam and the bearing areas of a cylinder unit following the gas-exchange cams form a continuous unit without interruptions. These high-pressure pumps 7a, 7b each have a plunger that is actuated by one of the roller tappets 18 and that is designed without a control edge so that it always conveys a prescribed amount of fuel as long as the feed is sufficient. As mentioned above, the fuel pressure in the high-pressure accumulator 11 is controlled or regulated by the pressure-control valve of the control block 6 in that the amount of fuel fed to the high-pressure pumps 7a, 7b is controlled. In the embodiment shown, the control block 6 is positioned between the high-pressure pumps 7a, 7b. In an alternative embodiment, this control block 6 can also be integrated into the support frame 3 of the fuel filter 4.

1-10. (canceled)

11. An internal combustion engine that includes an injection system configured as a high-pressure accumulator system, the internal combustion engine comprising:
at least one high-pressure pump;
a tubular high-pressure accumulator having a plurality of connection fittings;
a high-pressure supply line connecting the at least one high-pressure pump to the tubular high-pressure accumulator; and
a plurality of high-pressure connection lines each connected to one of the connection fittings and configured to provide a valve-controlled flow connection to a respective one of a plurality of injection valves of a cylinder row of the internal combustion engine,
wherein each of the plurality of connection fittings is disposed laterally offset relative to the corresponding injection valve, and wherein an absolute magnitude of the offset is the same for each of the injection valves.

12. The internal combustion engine as recited in claim 11, further comprising a cylinder head having a plurality of cylinders and pistons, and a plurality of working areas, each formed by a respective cylinder, piston, and the cylinder head, and wherein each of the plurality of injection valves protrudes into one of the working areas.

13. The internal combustion engine as recited in claim 11, wherein an orientation of the offset for a connection fitting at at least one end of the cylinder row is opposite to an orientation of the offset for the other connection fittings.

14. The internal combustion engine as recited in claim 11, wherein the plurality of high-pressure connection lines have two different shapes, and each high-pressure connection line has one of the two different shapes.

15. The internal combustion engine as recited in claim 11, wherein the plurality of high-pressure connection lines are configured identically.

16. The internal combustion engine as recited in claim 11, wherein the at least one high-pressure pump is disposed close to the cylinder head in a housing, and wherein the at least one high-pressure pump is actuated by an injection pump cam disposed on a gas-exchange camshaft.

17. The internal combustion engine as recited in claim 16, wherein the housing is a crankcase of the internal combustion engine.

18. The internal combustion engine as recited in claim 16, wherein the at least one high-pressure pump includes two high-pressure pumps disposed next to each other at a distance and associated with adjacent cylinders.

19. The internal combustion engine as recited in claim 18, wherein the high-pressure connection supply lines are configured identically.

20. The internal combustion engine as recited in claim 11, further comprising a control block disposed on an inlet side of the at least one high-pressure pump and configured to control or regulate a fuel pressure to be established in the high-pressure accumulator.

21. The internal combustion engine as recited in claim 20, wherein the control block is disposed adjacent to the at least one high-pressure pump.

22. The internal combustion engine as recited in claim 21, wherein the at least one high-pressure pump includes two high-pressure pumps and the control block is disposed between the two high-pressure pumps.

23. The internal combustion engine as recited in claim 20, further comprising a fuel delivery pump and a fuel filter having a support frame disposed between a fuel delivery pump and the at least one high-pressure pump, and wherein the control block is integrated into the support frame.
